(19) United States
(12) Patent Application Publication
(10) Pub. No.: US 2025/0087090 A1
(43) Pub. Date: Mar. 13, 2025

(54) ARTIFICIAL INTELLIGENCE-BASED PARKING SYSTEM USING QR CODE

(71) Applicant: LIGHTVISION CORP., Seoul (KR)

(72) Inventors: Jin Ha JEONG, Yongin-si (KR); Moon Soo RA, Bucheon-si (KR); Hea Yun LEE, Suwon-si (KR); Hyun Ji LEE, Seoul (KR)

(21) Appl. No.: 18/959,889

(22) Filed: Nov. 26, 2024

Related U.S. Application Data
(63) Continuation of application No. PCT/KR2023/006532, filed on May 15, 2023.

(30) Foreign Application Priority Data
Jun. 2, 2022 (KR) 10-2022-0067578
Aug. 31, 2022 (KR) 10-2022-0109598

(51) Int. Cl. G08G 1/14; G01C 21/36; G06K 7/14; G06V 20/52; G07B 15/02; G08G 1/04; H04N 7/18

(52) U.S. Cl. CPC G08G 1/141; G01C 21/3685; G06V 20/52; G07B 15/02; G08G 1/04; H04N 7/18; G06K 7/1417

(57) ABSTRACT

A method for providing an AI-based parking system includes: (a) scanning a QR code installed in a parking area using a user device and transmitting parking area identification information to the server; (b) matching and storing an entry time and the parking area identification information to complete entry of a vehicle, identifying location information stored in association with the parking area identification information, and transmitting a vehicle entry completion message to the user device when the user device inputs and transmits a mobile number, a vehicle number, and payment method information to the server; and (c) performing an exit process of the vehicle connected and paying a parking fee based on the payment method information when a vehicle exit signal is received from the user device or it is determined that the vehicle has exited based on a signal received from a CCTV installed in the parking area.

### CROSS-REFERENCE TO RELATED APPLICATION

This application is a Continuation of International Application No. PCT/KR2023/006532 filed on May 15, 2023, which claims priority of Korean Patent Application Nos. 10-2022-0109598 filed on Aug. 31, 2022, and 10-2022-0067578 filed on Jun. 2, 2022, in the Korean Intellectual Property Office, the entire contents of which are incorporated herein by reference.

### TECHNICAL FIELD

The present disclosure pertains to an artificial intelligence (AI)-based parking system using a QR code. More specifically, it relates to providing a convenient and fast artificial intelligence-based parking service utilizing QR codes in parking lots.

### BACKGROUND

The issue of insufficient parking space due to the increasing number of vehicles has been persistently raised. While public parking lots could be a potential solution, securing and selecting a suitable site is challenging, and the high costs involved remain a significant obstacle. Even if a site is selected and a parking lot is built, additional costs for actual management, such as maintenance costs and labor costs, are incurred. Furthermore, in the case of manned operation, there are limitations on operating hours.

A conventional parking system has a parking barrier to require vehicles to stop upon entry and exit. In the case of exiting the parking lot, more time is needed for payment, and, thus, congestion occurs at the exit.

Further, as for an on-street or off-street parking lot, a parking attendant has to manually check entry times and a driver has to pay the parking attendant when exiting the parking lot, which requires extra time.

Therefore, there is a growing need for an AI-based parking system that not only works for large parking lots with parking barriers but also for barrier-free on-street and off-street parking lots as well as indoor parking lots to help users conveniently locate their parked vehicles and more easily exit the parking lots.

### DISCLOSURE OF THE INVENTION

### Problems to be Solved by the Invention

In view of the foregoing, the present disclosure is conceived to provide an AI-based parking system using a QR code installed in a parking lot to enable convenient and quick entry and exit of vehicles.

### Means for Solving the Problems

An aspect of the present disclosure provides a method for providing an AI-based parking system using a QR code, which is performed by a server, including: (a) a process of scanning a QR code installed in a parking area using a user device and transmitting parking area identification information to the server; (b) a process of matching and storing an entry time and the parking area identification information to complete entry of a vehicle, identifying location information stored in association with the parking area identification information, and transmitting a vehicle entry completion message to the user device when the user device inputs and transmits a mobile number, a vehicle number, and payment method information to the server; and (c) a process of performing an exit process of the vehicle connected to the user device and paying a parking fee based on the payment method information when a vehicle exit signal is received from the user device or it is determined that the vehicle has exited based on a signal received from a CCTV installed in the parking area.

Also, the method further includes (c-1) a process of transmitting an additional identification code of a current location to the server by the user device or receiving previously stored location information or a GPS value from the user device and providing guide information for the user to move to a parking location of the vehicle based on the current location of the user device before the process (c).

Further, the method further includes a process of attaching a printout of an additional identification code at each location in a parking lot and transmitting the additional identification code to the server when the user device scans the additional identification code before the process (c-1), and the additional identification code includes information about a current location in a parking lot.

Furthermore, if a camera is installed in a parking lot, the method further includes: a process of checking a vacant parking area in the parking lot, identification information of the parking area, and a location of the parking area; a process of providing information about the location of the vacant parking area to the user device by displaying the information on a map; and a process of providing a service capable of providing guidance of a route from a current location of the user device to the vacant parking area before the process (a).

Moreover, if a camera is installed in a parking lot, the process (c) includes: a process of checking identification information of the vehicle when the vehicle leaves a predetermined parking area, detecting an exit time of the vehicle through the camera, calculating a time elapsed from the previously stored entry time, and making automatic payment for an amount corresponding to a parking duration based on the payment method information; and a process of transmitting, to the user device, a message indicative of a result of the automatic payment when the automatic payment is completed.

Also, the process (c-1) further includes a process of providing a current location, a parking location, and a moving route to the user device by displaying them on a map of the parking lot and displaying the current location of the user device on the moving route by using at least one of a GPS, an accelerometer, and a gyro sensor in the user device.

Further, in the process (c-1), the moving route is displayed in an AR image in a state where a camera mode of the user device is executed.

Furthermore, before the process (c), the moving route is displayed in an AR image on the user device, and the AR image displays identification information of a parking location only in a direction corresponding to the parking location, and when the user device searches for the AR image via 360-degree rotation, the user device reaches the parking area by moving in a direction in which the AR image is continuously displayed.

Moreover, the process (a) includes: a process of connecting a controller of the vehicle and the user device based on a local area network; a process of displaying a rear camera image in a center facia of the vehicle when the vehicle performs a head-out parking and transmitting an image including a QR code to the user device when the image including the QR code is detected from the rear camera image of the vehicle; and a process of decoding the QR code from the image by the user device, automatically accessing a link associated with the QR code, and transmitting the parking area identification information included in the QR code and the mobile number of the user device to the server.

Also, the process (a) includes: a process of connecting a controller of the vehicle and the user device based on a local area network; a process of displaying a rear camera image in a center facia of the vehicle when the vehicle performs a head-out parking; and a process of detecting an image including a QR code from the rear camera image of the vehicle by the user device, decoding the QR code from the image by the user device, and accessing a link associated with the QR code to transmit the parking area identification information included in the QR code and the mobile number of the user device to the server. Another aspect of the present disclosure provides a server for providing an AI-based parking service using a QR code, including: a memory that stores a program related to a method for providing the AI-based parking service using the QR code; and a processor configured to execute the program, and the method includes: (a) if a camera is installed in a parking lot, a process of checking a vacant parking area in the parking lot, identification information of the parking area, and a location of the parking area, providing information about the location of the vacant parking area to a user device by displaying the information on a map, and providing a service capable of providing guidance of a route from a current location of the user device to the vacant parking area; (b) a process of scanning the QR code installed in the parking area and transmitting parking area identification information to the server by the user device; (c) a process of matching and storing an entry time and the parking area identification information to complete entry of a vehicle, identifying location information stored in association with the parking area identification information, and transmitting a vehicle entry completion message to the user device when the user device inputs and transmits a mobile number, a vehicle number, and payment method information to the server; and (d) a process of performing an exit process of the vehicle connected to the user device and paying a parking fee based on the payment method information when a vehicle exit signal is received from the user device or it is determined that the vehicle has exited based on a signal received from a CCTV installed in the parking area.

Also, the method further includes (d-1) a process of transmitting an additional identification code of a current location to the server by the user device or receiving previously stored location information or a GPS value from the user device and providing guide information for the user to move to a parking location of the vehicle based on the current location of the user device before the process (d).

Further, the method further includes a process of attaching a printout of an additional identification code at each location in a parking lot and transmitting the additional identification code to the server when the user device scans the additional identification code before the process (d-1), and the additional identification code includes information about a current location in a parking lot. Furthermore, the process (d) includes: a process of checking identification information of the vehicle when the vehicle leaves a predetermined parking area, detecting the an exit time of the vehicle through the camera, calculating a time elapsed from the previously stored entry time, and making automatic payment for an amount corresponding to a parking duration based on the payment method information, and a process of transmitting, to the user device, a message indicative of a result of the automatic payment when the automatic payment is completed.

Moreover, the process (d-1) further includes a process of providing a current location, a parking location, and a moving route to the user device by displaying them on a map of the parking lot and displaying the current location of the user device on the moving route by using at least one of a GPS, an accelerometer, and a gyro sensor in the user device.

Also, in the process (d-1), the moving route is displayed in an AR image in a state where a camera mode of the user device is executed.

Further, before the process (c), the moving route is displayed in an AR image on the user device, and the AR image displays identification information of a parking location only in a direction corresponding to the parking location, and when the user device searches for the AR image via 360-degree rotation, the user device reaches the parking area by moving in a direction in which the AR image is continuously displayed.

Furthermore, the process (b) includes: a process of connecting a controller of the vehicle and the user device based on a local area network; a process of displaying a rear camera image in a center facia of the vehicle when the vehicle performs a head-out parking and transmitting an image including a QR code to the user device when the image including the QR code is detected from the rear camera image of the vehicle; and a process of decoding the QR code from the image by the user device, automatically accessing a link associated with the QR code, and transmitting the parking area identification information included in the QR code and the mobile number of the user device to the server.

Moreover, the process (b) includes: a process of connecting a controller of the vehicle and the user device based on a local area network; a process of displaying a rear camera image in a center facia of the vehicle when the vehicle performs a head-out parking; and a process of detecting an image including a QR code from the rear camera image of the vehicle, decoding the QR code from the image by the user device, and accessing a link associated with the QR code to transmit the parking area identification information included in the QR code and the mobile number of the user device to the server.

### Effects of the Invention

According to the present disclosure, it is possible to provide a convenient and quick AI-based parking system using a QR code that enables a user device to input predetermined parking information by scanning the QR code, performs a vehicle entry process, a vehicle exit process and a payment process, and provides guidance to a parking area of a vehicle for vehicle exit based on GPS location of the user device.

### BRIEF DESCRIPTION OF THE DRAWINGS

FIG. 1 is a structural diagram of an AI-based parking system using a QR code according to an embodiment of the present disclosure.

FIG. 2 is a structural diagram of a server according to an embodiment of the present disclosure.

FIG. 3 is a structural diagram of an AI-based parking system using a QR code in a parking lot equipped with a parking camera according to a second embodiment of the present disclosure.

FIG. 4 is a diagram showing the usage flow for each process of the AI-based parking system using a QR code according to an embodiment of the present disclosure.

FIG. 5 is a flowchart showing processes of the AI-based parking system using a QR code according to an embodiment of the present disclosure.

FIG. 6 shows an example of a vehicle parking process and a vehicle exit process of the AI-based parking system using a QR code according to an embodiment of the present disclosure.

FIG. 7 shows an example of a QR code in the AI-based parking system using a QR code according to an embodiment of the present disclosure.

FIGS. 8A, 8B, 8C, 8D and 8E shows an example of a vehicle entry process of the AI-based parking system using a QR code according to an embodiment of the present disclosure.

FIG. 9A shows an example where a user device scans an additional identification code attached to a parking lot according to an embodiment of the present disclosure.

FIGS. 9B-A and 9B-B shows an example of guidance information for vehicle exit in the AI-based parking system using a QR code according to an embodiment of the present disclosure.

FIGS. 10A and 10B shows an example of a vehicle exit process of the AI-based parking system using a QR code according to an embodiment of the present disclosure.

FIG. 11 is a flowchart showing processes of the AI-based parking system using a QR code in the parking lot equipped with the parking camera according to the second embodiment of the present disclosure.

FIG. 12 shows an example of a vehicle parking process and a vehicle exit process of the AI-based parking system using a QR code in the parking lot equipped with the parking camera according to the second embodiment of the present disclosure.

FIGS. 13A, 13B, 13C and 13D shows an example of a search for a parking lot and guidance to a vacant parking area in the AI-based parking system using a QR code in the parking lot equipped with the parking camera according to the second embodiment of the present disclosure.

FIGS. 14A, 14B, 14C and 14D shows an example of an application of the AI-based parking system using a QR code according to an embodiment of the present disclosure.

### BEST MODE FOR CARRYING OUT THE INVENTION

Hereafter, example embodiments will be described in detail with reference to the accompanying drawings so that the present disclosure may be readily implemented by a person with ordinary skill in the art. However, it is to be noted that the present disclosure is not limited to the example embodiments but can be embodied in various other ways. In the drawings, parts irrelevant to the description are omitted for the simplicity of explanation, and like reference numerals denote like parts throughout the whole document.

Throughout this document, the term “connected to” may be used to designate a connection or coupling of one element to another element and includes both an element being “directly connected to” another element and an element being “electronically connected to” another element via another element. Further, throughout the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “unit” includes a unit implemented by hardware or software and a unit implemented by both of them. One unit may be implemented by two or more pieces of hardware, and two or more units may be implemented by one piece of hardware. However, the “unit” is not limited to the software or the hardware and may be stored in an addressable storage medium or may be configured to implement one or more processors. Accordingly, the “unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided by the “unit” may be either combined into a smaller number of components and “units” or divided into a larger number of components and “units”. Moreover, the components and “units” may be implemented to reproduce one or more CPUs within a device or a security multimedia card.

The term “user device” to be described below may be implemented with computers or portable devices which can access a server or another device through a network. Herein, the computers may include, for example, a notebook, a desktop, a laptop, and a VR HMD (e.g., HTC VIVE, Oculus Rift, GearVR, DayDream, PSVR, etc.) equipped with a WEB browser. Herein, the VR HMD includes all of models for PC (e.g., HTC VIVE, Oculus Rift, FOVE, Deepon, etc.), mobile (e.g., GearVR, DayDream, Baofeng Mojing, Google Cardboard, etc.) and console (PSVR), and stand-alone models (e.g., Deepon, PICO, etc.). The portable devices are, for example, wireless communication devices that ensure portability and mobility and may include a smart phone, a tablet PC, a wearable device and various kinds of devices equipped with a communication module such as Bluetooth (BLE, Bluetooth Low Energy), NFC, RFID, ultrasonic waves, infrared rays, WiFi, LiFi, and the like. Further, the term “network” refers to a connection structure that enables information exchange between nodes such as devices, servers, etc. and includes LAN (Local Area Network), WAN (Wide Area Network), Internet (WWW: World Wide Web), a wired or wireless data communication network, a telecommunication network, a wired or wireless television network, and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi, and the like, but may not be limited thereto.

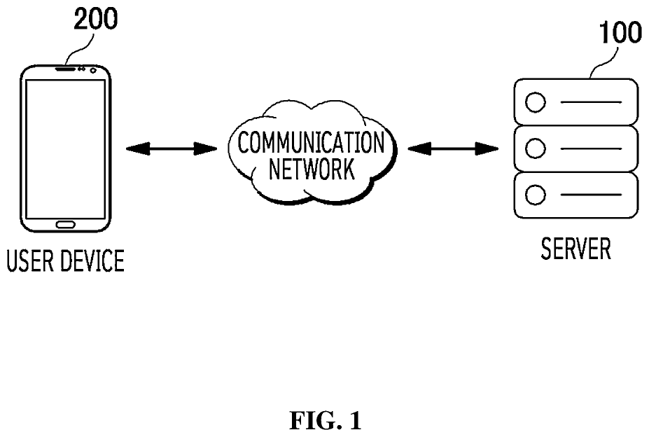

First, a structure of a system according to an embodiment of the present disclosure will be described with reference to FIG. 1.

Referring to FIG. 1, the system according to an embodiment of the present disclosure includes a server 100 and a user device 200.

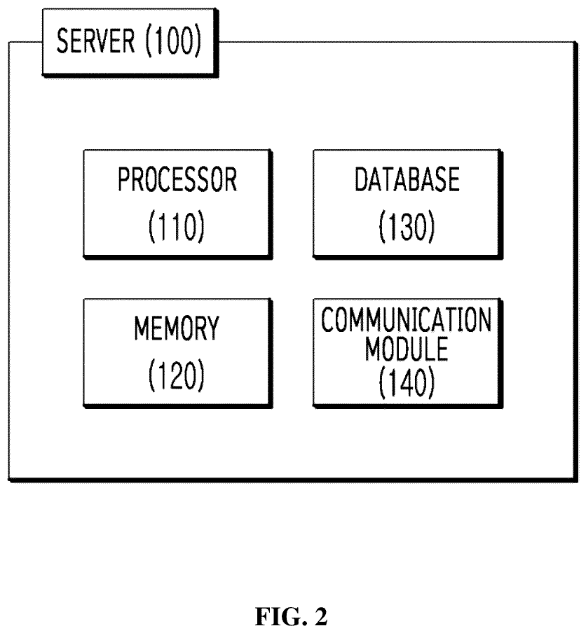

The server 100 will be described with reference to FIG. 2. Referring to FIG. 2, the server 100 according to the present disclosure includes a processor 110, a memory 120, a database 130, and a communication module 140.

The processor 110 executes a parking program stored in the memory 120 to enable the user device 200 to perform a vehicle entry process, a vehicle exit process, and a payment process. The database 130 stores parking information that the user device 200 inputs when a vehicle enters a parking lot, and the parking information includes a mobile number, a vehicle number, and encrypted payment card information. When the user device 200 is provided with an AI-based parking system by accessing a parking application or a parking web page, the communication module 140 performs communication with the user device 200 to provide the parking system.

The user device 200 accesses the parking application or the parking web page by scanning a QR code provided in the parking lot to perform a vehicle entry process, a vehicle exit process, and a payment process.

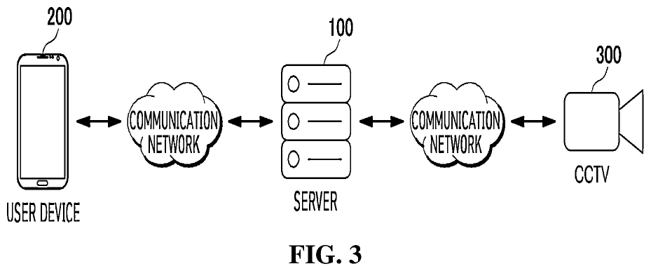

Hereafter, a structure of an AI-based parking system using a QR code in a parking lot equipped with a parking camera according to a second embodiment of the present disclosure will be described with reference to FIG. 3.

Referring to FIG. 3, the parking system according to the second embodiment of the present disclosure includes the server 100, the user device 200, and a CCTV 300.

The CCTV 300 may also be referred to as a camera, and serves to continuously monitor the parking lot and transmits a vacant parking area in the parking lot, identification information of the parking area, and a location of the parking area to the server 100. When the vehicle arrives at the parking lot and enters the vacant parking area, the CCTV 300 recognizes a vehicle number and an entry time and transmits them to the server 100. Then, when the vehicle leaves the parking area, the CCTV 300 recognizes the vehicle number and an exit time and transmits them to the server 100.

Herein, information about the location of the parking area may be provided to the user device 200 so as to be displayed on a map.

The description of the server 100 and the user device 200 is similar to their foregoing description with reference to FIG. 1. Hereafter, content not shown in FIG. 1 will be described.

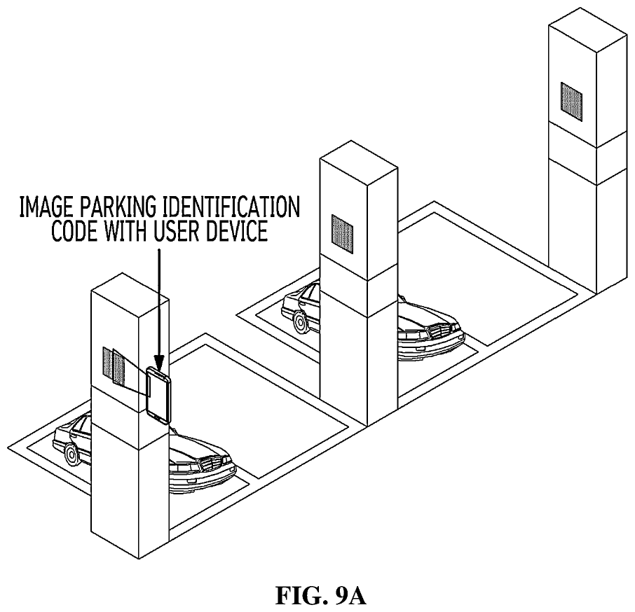

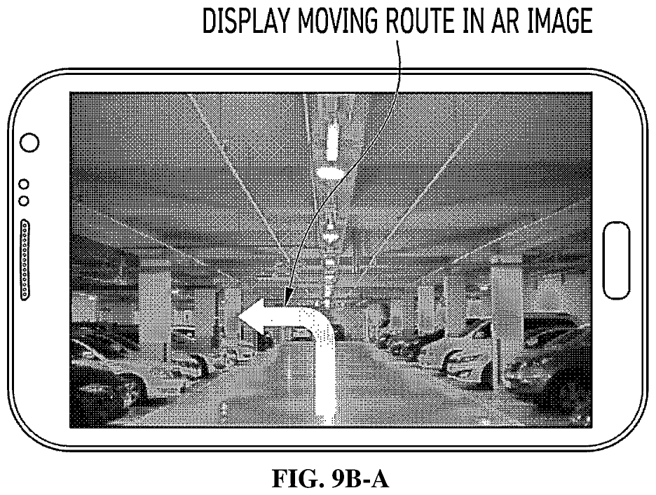

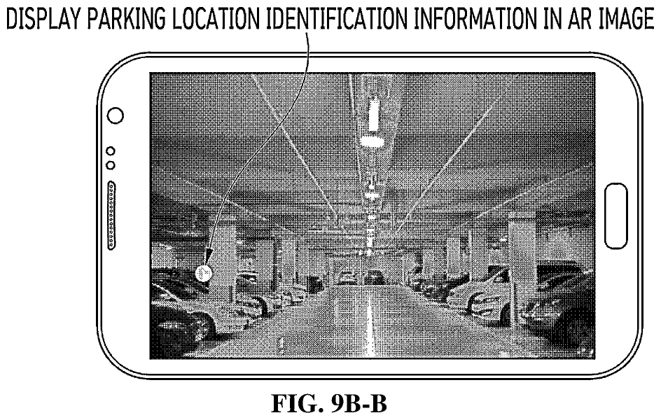

The server 100 may provide various kinds of information about the parking lot transmitted from the camera upon request of an application in the user device 200. This will be described in detail with reference to FIG. 9.

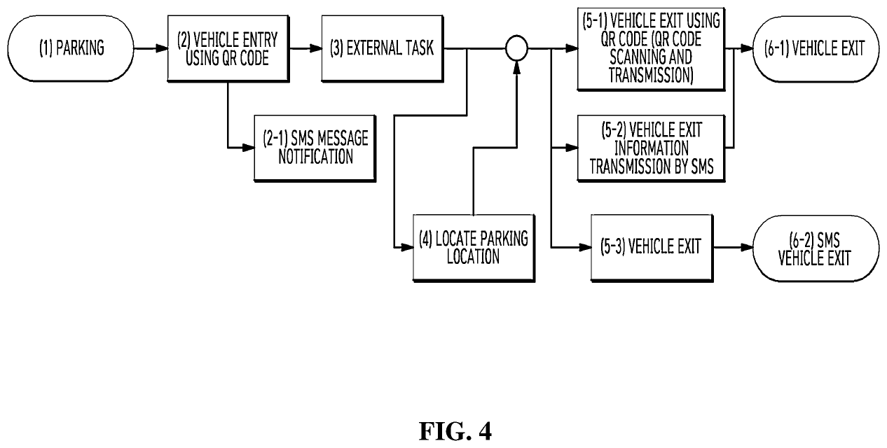

Hereafter, a diagram showing the usage flow for each process of the AI-based parking system using a QR code according to an embodiment of the present disclosure will be described with reference to FIG. 4.

When a vehicle to be parked (1) enters a parking lot by using a QR code (2), an SMS message arrives (2-1) and a user can do external tasks (3). When the user comes back, he/she locates a parking position (4) for vehicle exit and then performs vehicle exit by scanning and transmitting the QR code (5-1), by transmitting vehicle exit information in an SMS message (5-2), or just by exiting the parking lot (5-3). In the cases (5-1) and (5-2), the server directly performs a vehicle exit process, and in the case (5-3), the camera in the parking lot recognizes the vehicle exiting the parking lot and automatically recognizes exit of the vehicle, and transmits an SMS message indicating the completion of vehicle exit.

The overall detailed description of the present disclosure will be described with reference to the accompanying drawings.

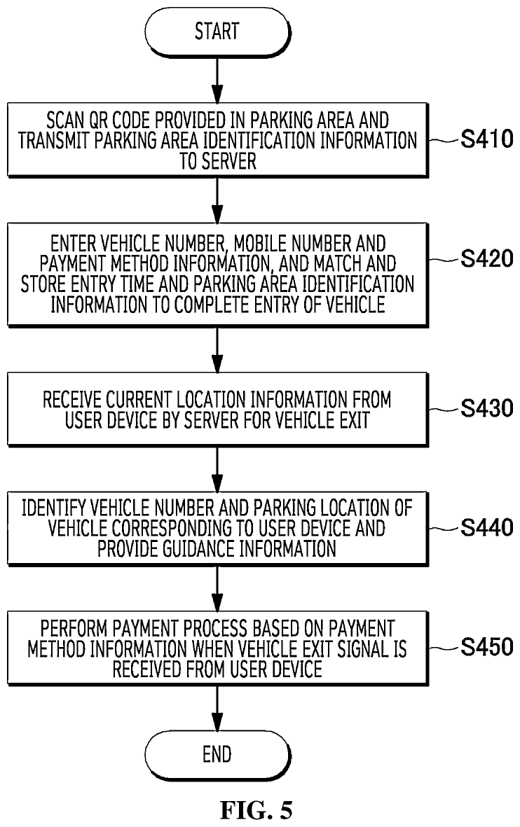

Hereafter, processes of the AI-based parking system using a QR code installed in a large parking lot without a parking barrier and a parking camera according to an embodiment of the present disclosure will be described in detail with reference to FIG. 5.

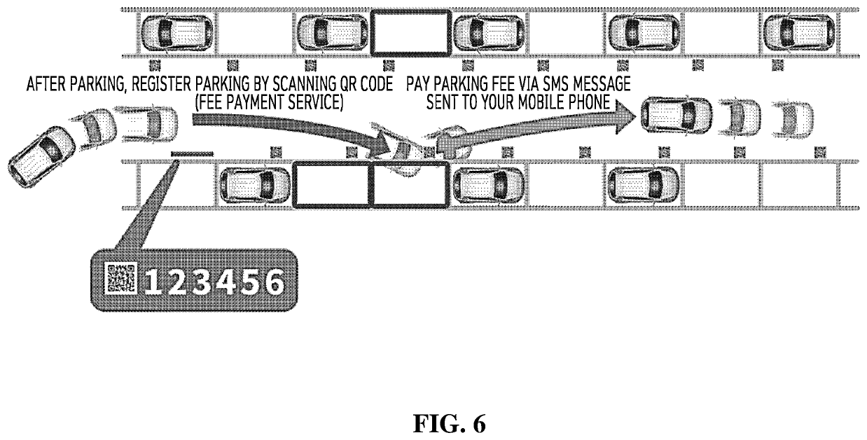

FIG. 6 shows an example of a vehicle entry process, a vehicle exit process and a payment process of the AI-based parking system using a QR code installed in a large parking lot without a parking barrier and a parking camera according to an embodiment of the present disclosure.

First, the user device 200 scans a QR code installed in a parking area and transmits parking area identification information to the server 100 (S410). The user inputs a vehicle number, a mobile number, and payment method information, and then, an entry time and the parking area identification information are matched and stored to complete entry of a vehicle (S420).

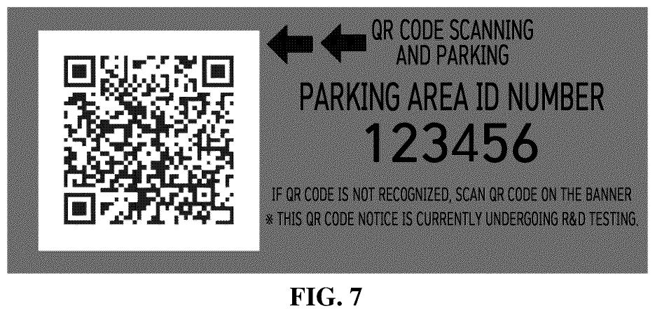

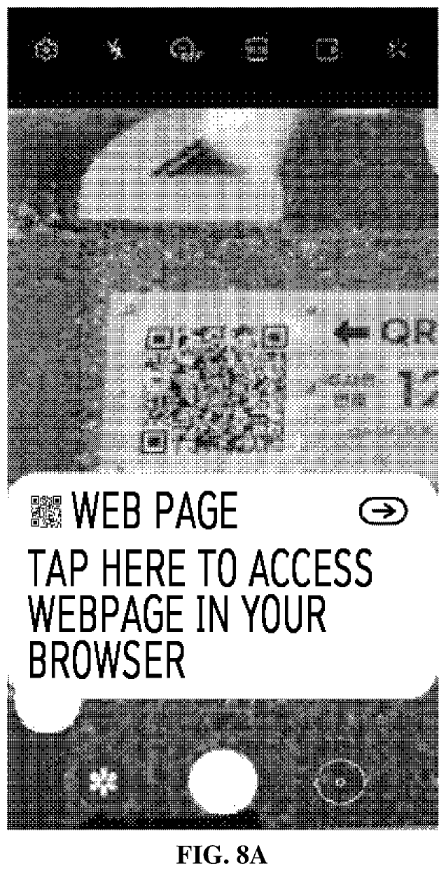

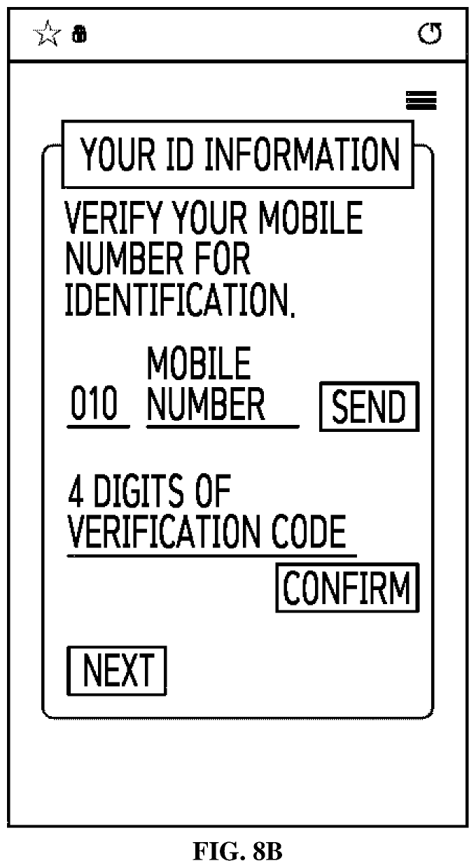

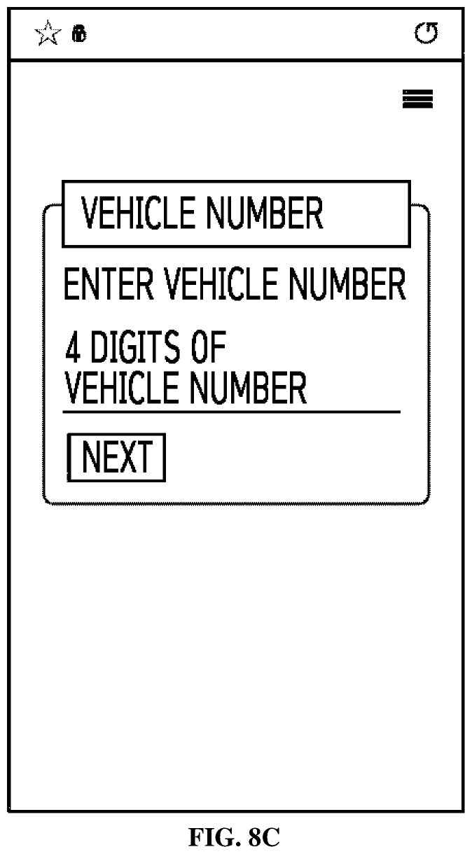

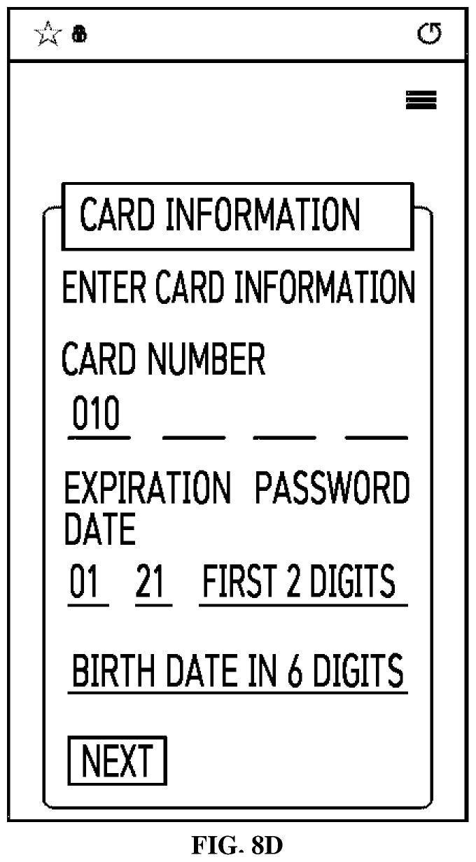

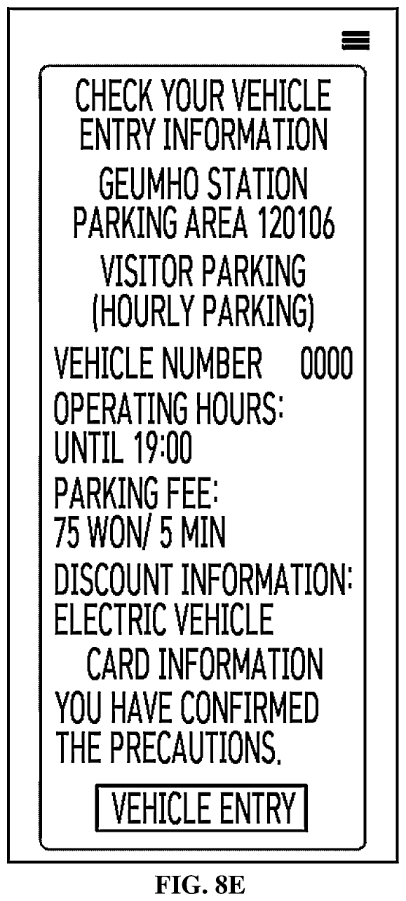

The processes S410 and S420 will be described with reference to FIG. 7, FIGS. 8A, 8B, 8C, 8D and 8E.

FIG. 7 shows an example of a QR code in the AI-based parking system using a QR code according to an embodiment of the present disclosure.

In the large parking lot without a parking barrier at the entrance of the parking lot and a parking lot surveillance camera, a vehicle enters a vacant parking area in the parking lot and then, a driver uses the user device 200 to scan a QR code installed in a portion of the floor or wall of the parking lot. The QR code includes parking area identification information, and the user device 200 transmits the parking area identification information corresponding to the imaged QR code to the server 100.

FIGS. 8A, 8B, 8C, 8D and 8E shows an example of a vehicle entry process of the AI-based parking system using a QR code according to an embodiment of the present disclosure.

In the process S410, when the user device 200 transmits the parking area identification information corresponding to the QR code to the server 100, the server 100 transmits a URL address for access to a web page to the user device 200 so as to be displayed in a portion of the user device 200 as shown in FIG. 8A. The user device 200 accesses the web page by inputting the URL address received from the server 100.

When the user device 200 completes the access to the web page, the screen as shown in FIG. 8B is displayed. After the user device 200 inputs a mobile number and requests an authentication number from the server 100, the user device 200 receives a message of authentication number from the server 100 and inputs the authentication number.

When the input of the mobile number and the authentication number is completed, the screen as shown in FIG. 8C for inputting a vehicle number is displayed and the user device 200 inputs four digits of the vehicle number or the whole vehicle number.

When the input of the vehicle number is completed, the screen as shown in FIG. 8D for inputting payment method information is displayed and the user device 200 inputs a card number, an expiration date, first two digits of a password, and a birth date.

When the input of the payment method information is completed, the user device 200 enters a final stage for vehicle entry as shown in FIG. 8E. When a driver taps a button Vehicle Entry, an entry time and parking area identification information are stored and the entry of the vehicle is completed.

Then, at the time of vehicle exit, the server 100 receives current location information from the user device 200 (S430). The server 100 identifies the vehicle number and the parking location of the vehicle corresponding to the user device 200 and provides guidance information (S440).

The process S430 will be described with reference to FIG. 9A. Referring to FIG. 9A, a printout of an additional identification code including information about the current location in the parking lot is attached at each location in the parking lot, and when the user device 200 scans the additional identification code and transmits it to the server 100, the server 100 transmits the current location information to the user device 200. Alternatively, a GPS value of the user device 200 is transmitted to the server 100. Then, the server 100 identifies the vehicle number and the parking location of the vehicle corresponding to the user device 200 and provides guidance information. Herein, the guidance information is provided in three ways.

In a first method, the server 100 provides a current location, a parking location, and a moving route to the user device 200 by displaying them on a map associated with the parking lot. A floor plan of the parking lot is provided to the user device 200, a current location of the user device 200 and a parking position of a vehicle having a vehicle number corresponding to the user device 200 are displayed on the floor plan, and a moving route from the current location to the parking location is displayed with a line on the floor plan. The user device 200 may use at least one of the GPS, the accelerometer, and the gyro sensor in the user device 200 to display the current location of the user device 200 on the moving route.

A second method and a third method will be described with reference to FIGS. 9B-A and 9B-B.

FIGS. 9B-A and 9B-B shows an example of guidance information for vehicle exit in the AI-based parking system using a QR code according to an embodiment of the present disclosure.

In the second method, the moving route is displayed in an AR image in a state where a camera mode of the user device 200 is executed. When the camera mode of the user device 200 is executed as shown in FIG. 9B-A, the moving route indicated by an arrow is displayed in an AR image on the screen, and the driver moves along the arrow direction with the user device 200. In this case, the user device 200 may use at least one of the GPS, the accelerometer, and the gyro sensor in the user device 200 to display a next pointing arrow along the moving route.

In the third method, the moving route is displayed in an AR image in a state where the camera mode of the user device 200 is executed, and identification information of the parking location is displayed in an AR image only in a direction corresponding to the parking location. Further, when the user device 200 searches for the AR image via 360-degree rotation, the user device 200 reaches a parking area by moving in a direction in which the AR image is continuously displayed.

In a state where the camera mode of the user device 200 is executed, identification information of the parking location is displayed via 360-degree rotation in a portion of the user device 200 in a direction corresponding to the parking location as shown in FIG. 9B-B. The driver moves in the corresponding direction and reaches the parking area according to the identification information displayed on the user device 200.

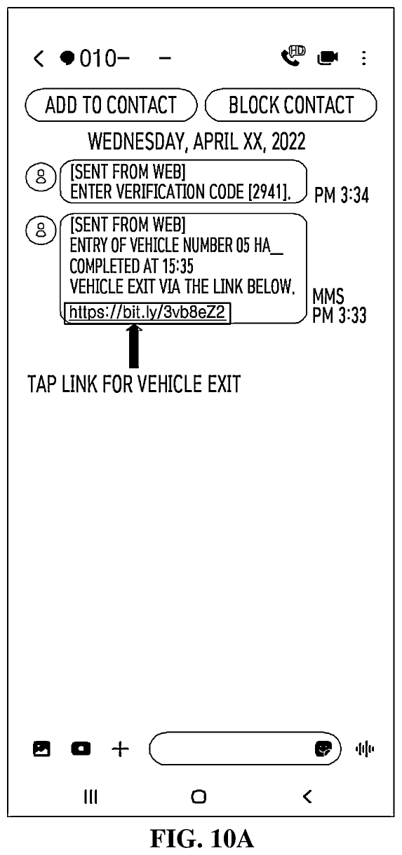

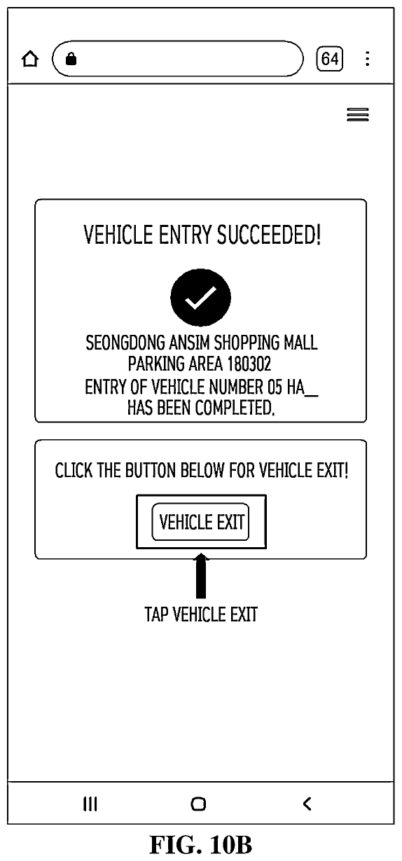

When a vehicle exit signal is received from the user device 200, the payment process is performed based on the payment method information (S450). When the driver reaches the parking area of the vehicle through the process S440, he/she performs the payment process for vehicle exit when. This will be described with reference to FIGS. 10A and 10B.

FIG. 10A shows a message of a URL on the screen when the entry of the vehicle is completed through the process S420. When the driver taps and inputs a URL link at the time of vehicle exit, he/she turns to a vehicle exit page as shown in FIG. 10B. On the corresponding screen, Vehicle Entry Succeeded is displayed, and when the driver taps and inputs Vehicle Exit displayed in a portion of the screen, the payment process is performed based on the payment method information input in the process S420.

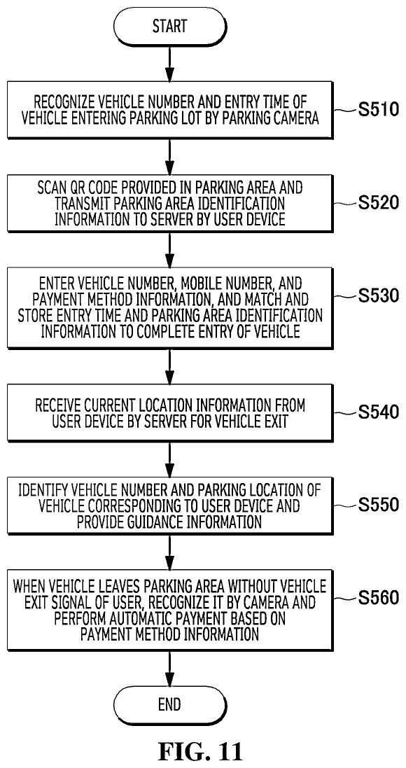

Hereafter, processes of the AI-based parking system using a QR code installed in a resident priority parking lot equipped with a parking camera without a parking barrier according to the second embodiment of the present disclosure will be described with reference to FIG. 11.

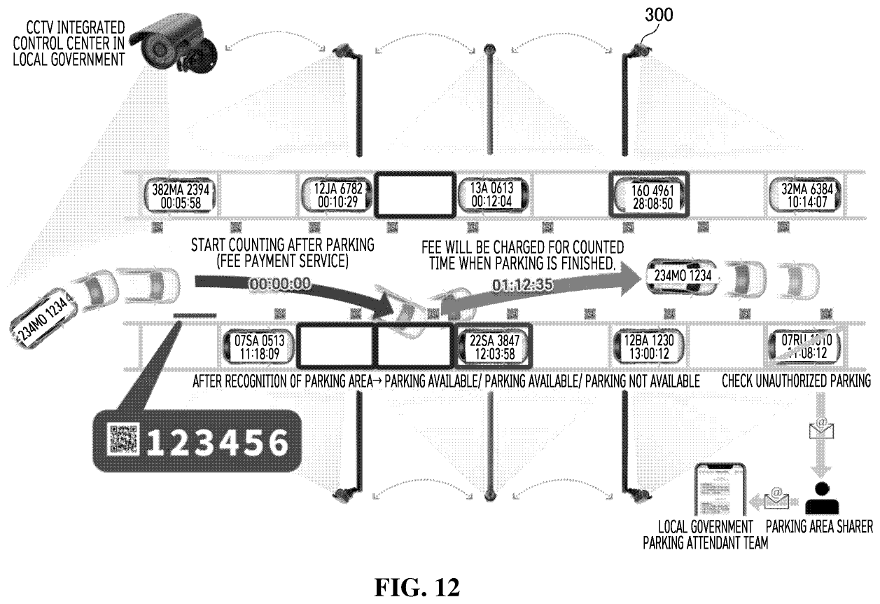

FIG. 12 shows an example of a vehicle entry process, a vehicle exit process and a payment process of the AI-based parking system using a QR code installed in the parking lot equipped with a parking camera according to the second embodiment of the present disclosure.

First, the parking camera recognizes a vehicle number and an entry time of a vehicle entering the parking lot (S510).

In the resident priority parking lot without a parking barrier at the entrance of the parking lot, a camera is installed by a local government or government and public office. The camera can record videos 24 hours a day for security purpose. In this case, when the vehicle arrives at the parking lot, the camera installed in the parking lot recognizes a vehicle number and an entry time of the vehicle that has entered a vacant parking area.

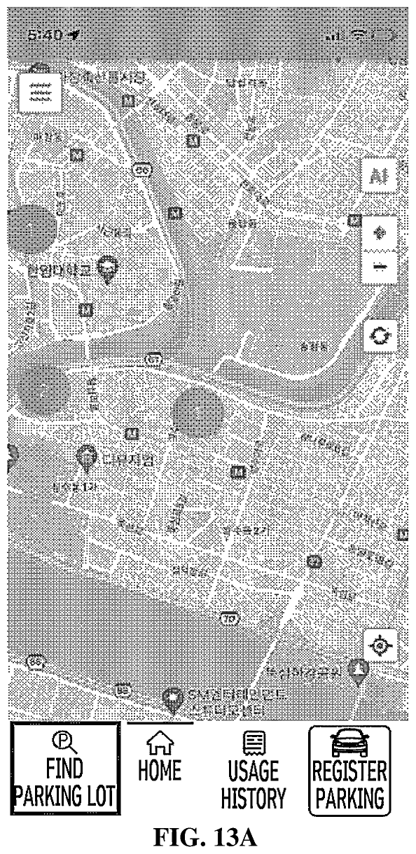

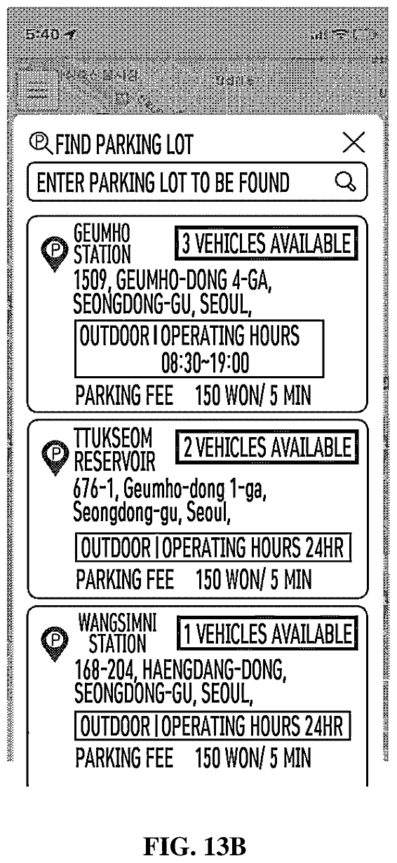

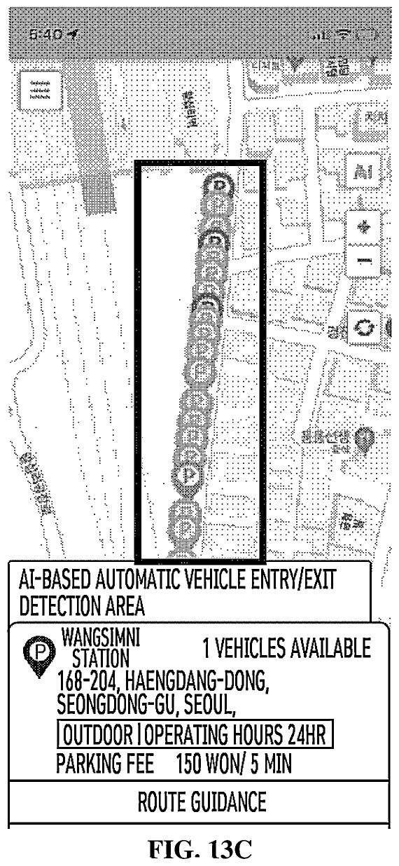

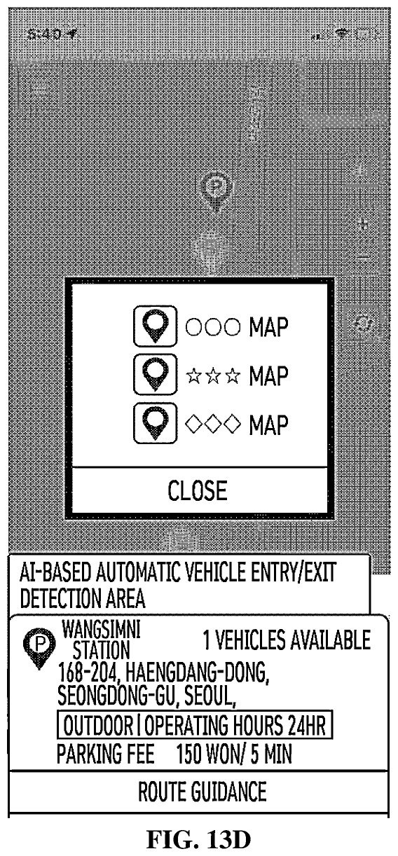

If an application is installed on the user device 200 according to an additional embodiment of the present disclosure, a location of the parking lot and the presence or absence of a vacant parking area may be checked through the application before the process S510 and a moving route from a current location of the vehicle to the parking lot may be provided. This will be described with reference to FIGS. 13A, 13B, 13C and 13D.

Hereafter, a search for a parking lot and guidance to a vacant parking area in the AI-based parking system using a QR code before a vehicle enters a parking lot equipped with a parking camera according to the second embodiment of the present disclosure will be described with reference to FIGS. 13A, 13B, 13C and 13D.

FIG. 13A shows vacant parking areas displayed with numbers on a map of the application. It is possible to search for a parking lot by tapping Find Parking Lot located in a bottom portion.

FIG. 13B shows a list of parking lots in response to the input of Parking Lot Search on the user device 200. This list includes names, addresses, the parking lot name, address, indoor or outdoor status, operating hours, parking fees, total number of available areas, and currently available areas of parking lots.

When the user device 200 inputs the number of available areas, parking areas of a selected parking lot is displayed in a portion of the user device 200 as shown in FIG. 13C. The user can check a vacant parking area, identification information of the parking area, and a location of the parking area through the camera. Further, information about the location of the vacant parking area may be provided to the user device 200 so as to be displayed on a map.

In this case, when the user device 200 inputs Route Guidance located in a bottom portion of FIG. 13C, the user device 200 may be provided with a service of providing guidance of a route from a current location of the user device 200 to the vacant parking area as shown in FIG. 13D. The user device 200 may select a service from among a plurality of services installed on the user device 200 to receive route guidance.

Then, the user device 200 scans a QR code intalled in the parking area and transmits parking area identification information to the server 100 (S520). The user inputs a vehicle number, a mobile number, and payment method information, and then, an entry time and the parking area identification information are matched and stored to complete entry of a vehicle (S530). Then, at the time of vehicle exit, the server 100 receives current location information from the user device 200 (S540). Thereafter, the server 100 identifies the vehicle number and the parking location of the vehicle corresponding to the user device 200 and provides guidance information (S550).

The description of the processes S520 to S550 is similar to their foregoing description of the processes S410 to S440 with reference to FIG. 5.

When the vehicle leaves the parking area without a vehicle exit signal of the user, the camera recognizes it and automatic payment is performed based on the payment method information (S560).

When the driver arrives at the parking area and drives away from the parking area without transmitting a vehicle exit signal, the system checks identification information of the vehicle and uses the camera to recognize the exit time. Then, when the recognized vehicle number and exit time are transmitted to the server 100, the server 100 calculates a parking duration by checking the vehicle number and entry time of the vehicle exiting the parking lot from among vehicle numbers previously stored in the process S510. Also, the server 100 performs automatic payment based on the payment method information previously input in the process S530.

When the automatic payment is completed, the server 100 may transmit a payment completion message to the mobile number input in the process S530.

Processes of the AI-based parking system using a QR code installed in a large parking area equipped with a parking camera without a parking barrier according to a third embodiment of the present disclosure are performed in the same manner as in the second embodiment.

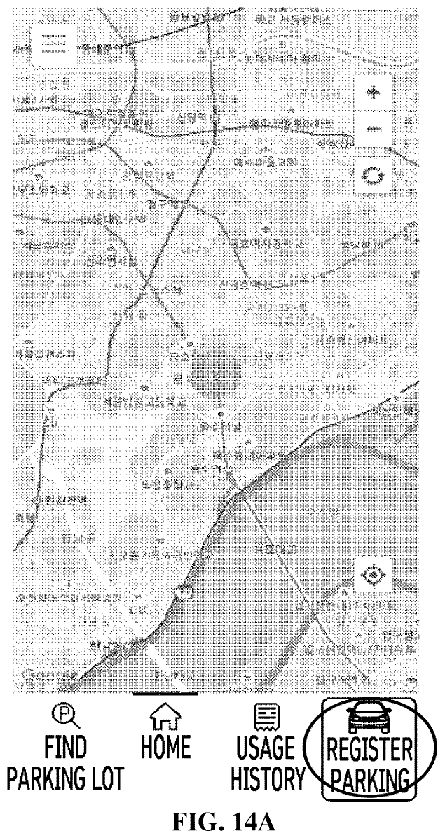

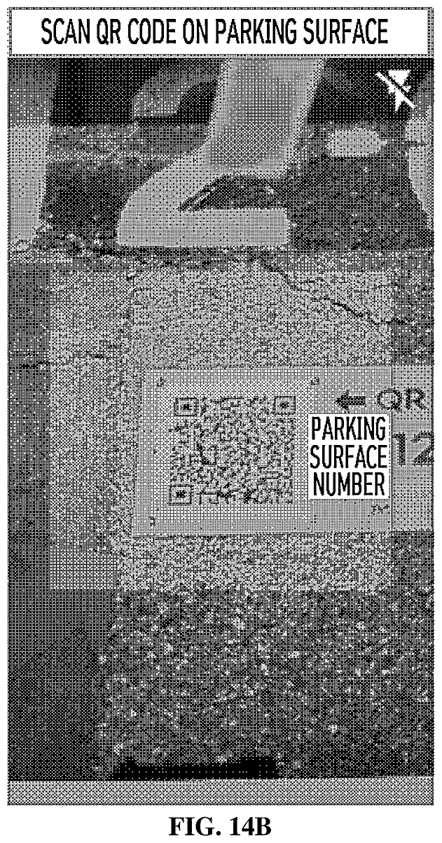

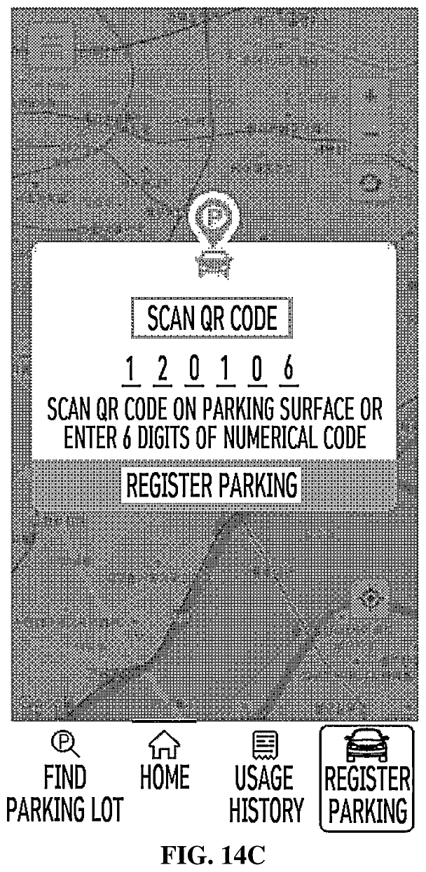

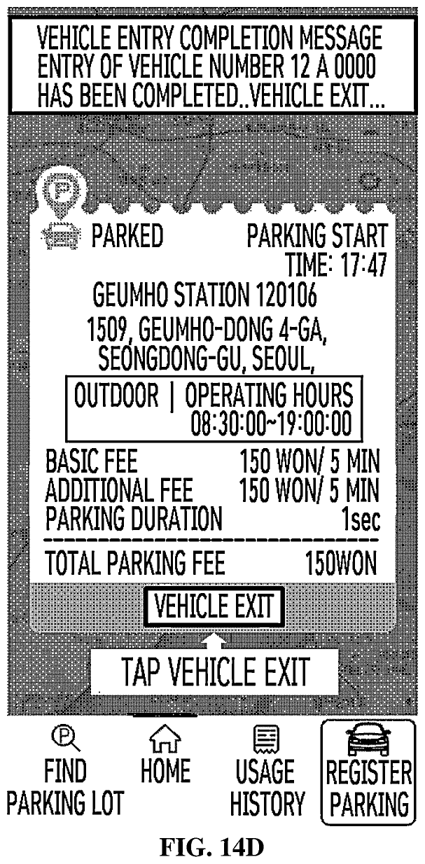

If an application is installed on the user device 200 according to an additional embodiment of the present disclosure and a vehicle number, a mobile number, and payment method information are pre-stored in the application, a vehicle entry process can be performed without performing the process S420 of FIG. 5 and the process S530 of FIG. 11. This will be described with reference to FIGS. 14A, 14B, 14C and 14D.

FIGS. 14A, 14B, 14C and 14D shows an example of an application of the AI-based parking system using a QR code according to an embodiment of the present disclosure.

After parking a vehicle in a parking area, the user executes the application on the user device 200 and taps Register Parking located in a portion of the application screen as shown in FIG. 14A, and uses the user device 200 to scan the QR code as shown in FIG. 14B.

When the user checks a parking area ID number provided by the application and taps Register Parking as shown in FIG. 14C, entry of the vehicle is completed as shown in FIG. 14D. In this case, a vehicle number, a mobile number, and payment method information are set after the application is installed, and, thus, no additional input is needed.

According to an additional embodiment of the present disclosure, if a controller of the vehicle is connected to the user device 200 based on a local area network, when the vehicle performs a head-out parking, a rear camera image is displayed in a center facia of the vehicle. Also, when an image including a QR code is detected from the rear camera image of the vehicle, the image is transmitted to the user device 200. The user device 200 extracts the QR code from the image received from the vehicle, automatically accesses a link associated with the QR code, and transmits parking area identification information included in the QR code and the mobile number of the user device 200 to the server 100. Accordingly, the driver can complete the entry of the vehicle without additional actions.

According to an additional embodiment of the present disclosure, if the controller of the vehicle is connected to the user device 200 based on the local area network, when the vehicle performs a head-out parking, a rear camera image is displayed in a center facia of the vehicle. Also, when an image including a QR code is detected from the rear camera image of the vehicle, the image is captured and detected by the user device 200. Then, the user device 200 accesses the link associated with the QR code in the detected image and transmits the parking area identification information included in the QR code and the mobile number of the user device 200 to the server 100.

The embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A method for providing an AI-based parking system using a QR code, which is performed by a server, comprising:
(a) a process of scanning a QR code installed in a parking area using a user device and transmitting parking area identification information to the server;
(b) a process of matching and storing an entry time and the parking area identification information to complete entry of a vehicle, identifying location information stored in association with the parking area identification information, and transmitting a vehicle entry completion message to the user device when the user device inputs and transmits a mobile number, a vehicle number, and payment method information to the server; and
(c) a process of performing an exit process of the vehicle connected to the user device and paying a parking fee based on the payment method information when a vehicle exit signal is received from the user device or it is determined that the vehicle has exited based on a signal received from a CCTV installed in the parking area.

2. The method for providing an AI-based parking system using a QR code of claim 1, further comprising:
a process of transmitting an additional identification code of a current location to the server by the user device or receiving previously stored location information or a GPS value from the user device and providing guide information for the user to move to a parking location of the vehicle based on the current location of the user device before the process (c).

3. The method for providing an AI-based parking system using a QR code of claim 1, further comprising:
a process of attaching a printout of an additional identification code at each location in a parking lot and transmitting the additional identification code to the server when the user device recognizes the additional identification code before the process (c-1),
wherein the additional identification code includes information about a current location in a parking lot.

4. The method for providing an AI-based parking system using a QR code of claim 1, further comprising:
wherein if a camera is installed in a parking lot, the method further includes:
a process of checking a vacant parking area in the parking lot, identification information of the parking area, and a location of the parking area;
a process of providing information about the location of the vacant parking area to the user device by displaying the information on a map; and
a process of providing a service capable of providing guidance of a route from a current location of the user device to the vacant parking area before the process (a).

5. The method for providing an AI-based parking system using a QR code of claim 1,
wherein if a camera is installed in a parking lot, the process (c) includes:
a process of checking identification information of the vehicle when the vehicle leaves a predetermined parking area, detecting an exit time of the vehicle through the camera, calculating a time elapsed from the previously stored entry time, and making automatic payment for an amount corresponding to a parking duration based on the payment method information; and
a process of transmitting, to the user device, a message indicative of a result of the automatic payment when the automatic payment is completed.

6. The method for providing an AI-based parking system using a QR code of claim 2,
wherein the process (c-1) further includes a process of providing a current location, a parking location, and a moving route to the user device by displaying them on a map of the parking lot and displaying the current location of the user device on the moving route by using at least one of a GPS, an accelerometer, and a gyro sensor in the user device.

7. The method for providing an AI-based parking system using a QR code of claim 6,
wherein in the process (c-1), the moving route is displayed in an AR image in a state where a camera mode of the user device is executed.

8. The method for providing an AI-based parking system using a QR code of claim 1,
wherein before the process (c), the moving route is displayed in an AR image on the user device, and the AR image displays identification information of a parking location only in a direction corresponding to the parking location, and when the user device searches for the AR image via 360-degree rotation, the user device reaches the parking area by moving in a direction in which the AR image is continuously displayed.

9. The method for providing an AI-based parking system using a QR code of claim 1,
wherein the process (a) includes:
a process of connecting a controller of the vehicle and the user device based on a local area network;
a process of displaying a rear camera image in a center facia of the vehicle when the vehicle performs a head-out parking and transmitting an image including a QR code to the user device when the image including the QR code is detected from the rear camera image of the vehicle; and
a process of decoding the QR code from the image by the user device, automatically accessing a link associated with the QR code, and transmitting the parking area identification information included in the QR code and the mobile number of the user device to the server.

10. The method for providing an AI-based parking system using a QR code of claim 1,
wherein the process (a) includes:
a process of connecting a controller of the vehicle and the user device based on a local area network;
a process of displaying a rear camera image in a center facia of the vehicle when the vehicle performs a head-out parking; and
a process of detecting an image including a QR code from the rear camera image of the vehicle by the user device, decoding the QR code from the image by the user device, and accessing a link associated with the QR code to transmit the parking area identification information included in the QR code and the mobile number of the user device to the server.

11. A server for providing an AI-based parking service using a QR code, comprising:
a memory that stores a program related to a method for providing the AI-based parking service using the QR code; and
a processor configured to execute the program,
wherein the method includes:
(a) if a camera is installed in a parking lot, a process of checking a vacant parking area in the parking lot, identification information of the parking area, and a location of the parking area, providing information about the location of the vacant parking area to a user device by displaying the information on a map, and providing a service capable of providing guidance of a route from a current location of the user device to the vacant parking area;
(b) a process of scanning a QR code installed in a parking area using a user device and transmitting parking area identification information to the server;
(c) a process of matching and storing an entry time and the parking area identification information to complete entry of a vehicle, identifying location information stored in association with the parking area identification information, and transmitting a vehicle entry completion message to the user device when the user device inputs and transmits a mobile number, a vehicle number, and payment method information to the server; and
(d) a process of performing an exit process of the vehicle connected to the user device and paying a parking fee based on the payment method information when a vehicle exit signal is received from the user device or it is determined that the vehicle has exited based on a signal received from a CCTV installed in the parking area.

12. The server for providing an AI-based parking service using a QR code of claim 11, further comprising:
(d-1) a process of transmitting an additional identification code of a current location to the server by the user device or receiving previously stored location information or a GPS value from the user device and providing guide information for the user to move to a parking location of the vehicle based on the current location of the user device before the process (d).

13. The server for providing an AI-based parking service using a QR code of claim 11, further comprising:
a process of attaching a printout of an additional identification code at each location in a parking lot and transmitting the additional identification code to the server when the user device recognizes the additional identification code before the process (d-1),
wherein the additional identification code includes information about a current location in a parking lot.

14. The server for providing an AI-based parking service using a QR code of claim 11,
wherein the process (d) includes:
a process of checking identification information of the vehicle when the vehicle leaves a predetermined parking area, detecting the exit time of the vehicle through the camera, calculating a time elapsed from the previously stored entry time, and making automatic payment for an amount corresponding to a parking duration based on the payment method information, and
a process of transmitting, to the user device, a message indicative of a result of the automatic payment when the automatic payment is completed.

15. The server for providing an AI-based parking service using a QR code of claim 12,
wherein the process (d-1) further includes a process of providing a current location, a parking location, and a moving route to the user device by displaying them on a map of the parking lot and displaying the current location of the user device on the moving route by using at least one of a GPS, an accelerometer, and a gyro sensor in the user device.

17. The server for providing an AI-based parking service using a QR code of claim 11,
wherein before the process (c), the moving route is displayed in an AR image on the user device, and the AR image displays identification information of a parking location only in a direction corresponding to the parking location, and when the user device searches for the AR image via 360-degree rotation, the user device reaches the parking area by moving in a direction in which the AR image is continuously displayed.

18. The server for providing an AI-based parking service using a QR code of claim 11,
wherein the process (b) includes:
a process of connecting a controller of the vehicle and the user device based on a local area network;
a process of displaying a rear camera image in a center facia of the vehicle when the vehicle performs a head-out parking and transmitting an image including a QR code to the user device when the image including the QR code is detected from the rear camera image of the vehicle; and
a process of decoding the QR code from the image by the user device, automatically accessing a link associated with the QR code, and transmitting the parking area identification information included in the QR code and the mobile number of the user device to the server.

19. The server for providing an AI-based parking service using a QR code of claim 11,
wherein the process (b) includes:
a process of connecting a controller of the vehicle and the user device based on a local area network; a process of displaying a rear camera image in a center facia of the vehicle when the vehicle performs a head-out parking; and
a process of detecting an image including a QR code from the rear camera image of the vehicle by the user device, decoding the QR code from the image by the user device, and accessing a link associated with the QR code to transmit the parking area identification information included in the QR code and the mobile number of the user device to the server.

20. A system for providing an AI-based parking service using a QR code, comprising:
a camera installed in a parking lot; and
a server,
wherein the system transmits an image of the parking lot captured by the camera to the server,
the server checks a vacant parking area in the parking lot, identification information of the parking area, and a location of the parking area from the camera image, provides information about the location of the vacant parking area to the user device by displaying the information on a map, and introduces a service capable of providing guidance of a route from a current location of the user device to the vacant parking area,
the server checks identification information when receiving an image of a QR code provided in the parking area from the user device,
when the server receives a mobile number, a vehicle number, and payment method information from the user device, the server matches and stores an entry time and the parking area identification information to complete entry of a vehicle, identifies location information stored in association with the parking area identification information, and transmits a vehicle entry completion message to the user device, and
when the server receives a vehicle exit signal from the user device or it is determined that the vehicle has exited based on a signal received from a CCTV installed in the parking area, the server performs an exit process of the vehicle connected to the user device and pays a parking fee based on the payment method information.
